(19) United States
(12) Patent Application Publication
(10) Pub. No.: US 2026/0340741 A1
(43) Pub. Date: Oct. 29, 2026

(54) RISK PREDICTION METHOD AND SYSTEM OF MAIZE CULTIVATION BASED ON CLIMATE CHANGE TREND

(71) Applicant: Farmland Irrigation Research Institute of CAAS, Xinxiang (CN)

(72) Inventors: Yun Gao, Xinxiang (CN); Yang Han, Xinxiang (CN); Chunya Ma, Xinxiang (CN); Ping Li, Xinxiang (CN)

(21) Appl. No.: 19/219,006

(22) Filed: May 27, 2025

(30) Foreign Application Priority Data
Apr. 25, 2025 (CN) 2025105339138

(51) Int. Cl. G06Q 50/02; G06N 20/00; G06V 20/10; G06V 20/13

(52) U.S. Cl. CPC G06Q 50/02; G06N 20/00; G06V 20/13; G06V 20/188

(57) ABSTRACT

A risk prediction method and a risk prediction system of maize cultivation based on climate change trend are provided. The risk prediction method includes: acquiring climate-related data of maize cultivation; constructing a risk prediction model, in which the risk prediction model uses a LSTM-Transformer hybrid neural network to process time-series meteorological data, introduces a SHAP value interpretation model to quantify a contribution of each climatic factor to a risk of yield reduction and couples a DSSAT crop model with a risk probability prediction module; inputting the climate-related data into the risk prediction model; and determining a resultant risk result of maize cultivation through computational processing of the risk prediction model, in which the resultant risk result of maize cultivation includes a regional risk level map, optimization suggestions of planting window period and probability warning of extreme weather events. Accuracy of risk prediction of maize cultivation can be improved.

### TECHNICAL FIELD

The disclosure relates to the technical field of environmental prediction, and more particularly to a risk prediction method and a risk prediction system of maize cultivation based on climate change trend.

### BACKGROUND

As one of important food crops in the world, yield stability of maize is directly related to food security and sustainable development of agricultural economy. However, in recent years, affected by global climate change, extreme weather events (such as drought, flood, high temperature, etc.) occur frequently, leading to a significant increase in uncertainty faced by maize cultivation. Risk assessment methods in the related art mainly rely on historical meteorological statistics or empirical models, so that the risk assessment methods are difficult to accurately capture nonlinear dynamic characteristics under climate change and lack in-depth integration analysis of multi-source climate data, resulting in insufficient prediction accuracy. In addition, models in the related art often ignore analysis of contribution of key climatic factors to a risk of yield reduction, therefore limiting pertinence of risk prevention and control strategies.

### SUMMARY

The disclosure aims to provide a risk prediction method and a risk prediction system of maize cultivation based on climate change trend, so as to improve accuracy of risk prediction of maize cultivation.

To achieve above objective, the disclosure provides following technical solutions.

Specifically, a risk prediction method of maize cultivation based on climate change trend according to an embodiment of the disclosure includes:
acquiring climate-related data of maize cultivation, in which the climate-related data includes remote sensing data and field planting data, and the remote sensing data includes coupled model intercomparison project phase 6 (CMIP6) climate scenario data and satellite remote sensing vegetation index;
constructing a risk prediction model, in which the risk prediction model uses a long short-term memory (LSTM)-Transformer hybrid neural network to process time-series meteorological data, introduces a SHapley Additive exPlanations (SHAP) value interpretation model to quantify a contribution of each climatic factor to a risk of yield reduction and couples a decision support system for agrotechnology transfer (DSSAT) crop model with a risk probability prediction module (also referred to as risk probability predictor); and
inputting the climate-related data into the risk prediction model, and determining a resultant risk result of maize cultivation through computational processing of the risk prediction model, in which the resultant risk result of maize cultivation includes a regional risk level map, optimization suggestions of planting window period, and probability warning of extreme weather events.

In an embodiment, the acquiring climate-related data of maize cultivation includes:
simulating and generating the CMIP6 climate scenario data by using global climate models (GCMs), generating the satellite remote sensing vegetation index by using satellite remote sensing inversion, packaging the CMIP6 climate scenario data and the satellite remote sensing vegetation index into a data file, and naming the data file as the remote sensing data;
constructing a field internet of things sensor network, collecting data in a target region by using the field internet of things sensor network to obtain collected data, and storing the collected data in a file package named as the field planting data; and
storing the remote sensing data and the field planting data in a cloud blockchain after hash encryption, performing identity verification through public keys and private keys of both parties after receiving data extraction request, and carrying out data decryption and extraction after passing the identity verification.

In an embodiment, the constructing a risk prediction model includes:
acquiring a training data set; in which the training data set includes training data and corresponding training labels;
constructing a pre-training network based on a dual-driven framework of machine learning and mechanistic model; and
inputting the training data set into the pre-training network, performing parameter optimization with an objective of minimizing losses between network outputs and the training labels, and determining the pre-training network with optimized optimal parameters as the risk prediction model.

In an embodiment, in a process of performing the parameter optimization, a feedback optimization mechanism and a dynamic weight allocation method are used. The dynamic weight allocation method uses dynamic weighted loss.

In an embodiment, the inputting the climate-related data into the risk prediction model; and the determining a resultant risk result of maize cultivation through computational processing of the risk prediction model, specifically include:
inputting the climate-related data into the risk prediction model, and firstly processing meteorological abnormal fluctuations by using a sliding window, then performing feature extraction and prediction, and determining the resultant risk result of maize cultivation.

In an embodiment, the risk prediction method of maize cultivation based on climate change trend further includes constructing a visual display platform.

In an embodiment, the constructing a visual display platform includes:
constructing a sliding dual platform, in which the sliding dual platform includes a first display platform and a second display platform, and a sliding between a platform page of the first display platform and a platform page of the second display platform is realized through a touch screen, the first display platform is configured to dynamically display the climate-related data through three interfaces based on different data types, and the second display platform is configured to display the resultant risk result of maize cultivation.

In one embodiment, the risk prediction method of maize cultivation based on climate change trend further including:
displaying the resultant risk result;
planting maize with a target variety type (e.g., heat-resistant maize) in a target planting window period according to the resultant risk result;
formulating differentiated irrigation and fertilization schemes according to the resultant risk result;
delineating a scope of subsidies in high-risk areas according to the resultant risk result; and
reserving corresponding materials and planning alternative logistics according to the resultant risk result.

Another embodiment of the disclosure provides the risk prediction system of maize cultivation based on climate change trend, including:
a data acquisition unit, configured to acquire the climate-related data of maize cultivation; in which the climate-related data includes the remote sensing data and the field planting data, and the remote sensing data includes the CMIP6 climate scenario data and the satellite remote sensing vegetation index;
a model construction unit, configured to construct the risk prediction model, in which the risk prediction model uses the LSTM-Transformer hybrid neural network to process the time-series meteorological data, introduces the SHAP value interpretation model to quantify the contribution of each climatic factor to the risk of yield reduction and couples the DSSAT crop model with the risk probability prediction module; and
a prediction unit, configured to input the climate-related data into the risk prediction model, and determine the resultant risk result of maize cultivation through the computational processing of the risk prediction model, in which the resultant risk result of maize cultivation includes the regional risk level map, the optimization suggestions of planting window period and the probability warning of extreme weather events.

In an embodiment, the data acquisition unit, the model construction unit and the prediction unit are embodied by at least one memory and at least one processor coupled to the at least one memory, and the at least one memory is stored with computer programs executable by the at least one processor.

According to embodiments of the disclosure, the disclosure discloses following technical effects.

The disclosure discloses the risk prediction method and the risk prediction system of maize cultivation based on climate change trend. The risk prediction method includes: acquiring the climate-related data of maize cultivation, in which the climate-related data includes the remote sensing data and the field planting data, and the remote sensing data includes the CMIP6 climate scenario data and the satellite remote sensing vegetation index; constructing the risk prediction model, in which the risk prediction model uses the LSTM-Transformer hybrid neural network to process the time-series meteorological data, introduces the SHAP value interpretation model to quantify the contribution of each climatic factor to the risk of yield reduction and couples the DSSAT crop model with the risk probability prediction module; inputting the climate-related data into the risk prediction model, and determining the resultant risk result of maize cultivation through the computational processing of the risk prediction model, in which the resultant risk result of maize cultivation includes the regional risk level map, the optimization suggestions of planting window period and the probability warning of extreme weather events. The disclosure integrates multi-source data and hybrid modeling technology to quantify the contribution of climatic factors to the risk, optimize planting decisions and improve ability to cope with extreme weather, thus further improving the accuracy of risk prediction of maize cultivation.

### BRIEF DESCRIPTION OF DRAWING

To more clearly describe technical solutions in embodiments of the disclosure or in the related art, attached drawings needed in the embodiments will be briefly introduced below. Apparently, the attached drawings described below are merely part of the embodiments of the disclosure. For those skilled in the art, other attached drawings can be obtained based on the attached drawings without creative labors.

FIG. 1 illustrates a flowchart of a risk prediction method of maize cultivation based on climate change trend according to an embodiment of the disclosure.

FIG. 2 illustrates a block diagram of a risk prediction system of maize cultivation based on climate change trend according to another embodiment of the disclosure.

### DETAILED DESCRIPTION OF EMBODIMENTS

Technical solutions in embodiments of the disclosure will be clearly and completely described below with reference to attached drawings of the embodiments of the disclosure. Apparently, the embodiments described are merely some of embodiments of the disclosure, rather than all of embodiments of the disclosure. Based on the described embodiments of the disclosure, other embodiments obtained by those skilled in the art without creative labors should fall within a scope of protection of the disclosure.

The disclosure aims to provide a risk prediction method and a risk prediction system of maize cultivation based on climate change trend, so as to improve accuracy of risk prediction of maize cultivation.

To make above objective, features and advantages of the disclosure more apparent and easier to understand, the disclosure will be further described in detail with reference to the attached drawings and embodiments.

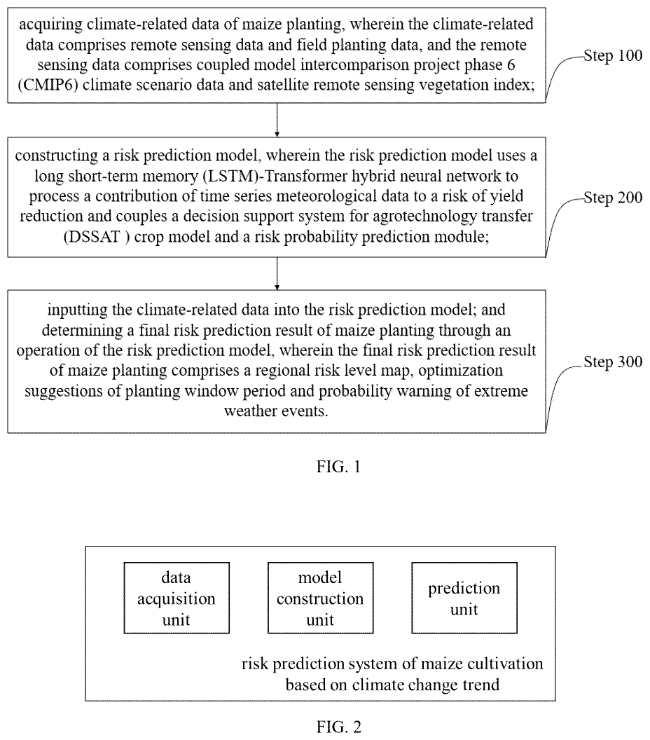

As illustrated in FIG. 1, the disclosure provides the risk prediction method of maize cultivation based on climate change trend, including following step 100 through step 300.
Step 100: climate-related data of maize cultivation is acquired. The climate-related data includes remote sensing data and field planting data. The remote sensing data includes CMIP6 climate scenario data and satellite remote sensing vegetation index.
Step 200: a risk prediction model is constructed. The risk prediction model uses a LSTM-Transformer hybrid neural network to process time-series meteorological data, introduces a SHAP value interpretation model to quantify a contribution of each climatic factor to a risk of yield reduction and couples a DSSAT crop model with a risk probability prediction module.
Step 300: the climate-related data is inputted into the risk prediction model; and a resultant risk result of maize cultivation is determined through computational processing of the risk prediction model. The resultant risk result of maize cultivation includes a regional risk level map, optimization suggestions of planting window period and probability warning of extreme weather events.

In an embodiment, a step that climate-related data of maize cultivation is acquired includes:
simulating and generating the CMIP6 climate scenario data by using GCMs model, generating the satellite remote sensing vegetation index by using satellite remote sensing inversion, packaging the CMIP6 climate scenario data and the satellite remote sensing vegetation index into a data file, and naming the data file as the remote sensing data;
constructing a field internet of things sensor network, collecting data in a target region by using the field internet of things sensor network to obtain collected data, and storing the collected data in a file package named the field planting data; and
storing the remote sensing data and the field planting data in a cloud blockchain after hash encryption, performing identity verification through public keys and private keys of both parties after receiving data extraction request, and carrying out data decryption and extraction after passing the identity verification.

In an embodiment, a step that a risk prediction model is constructed includes:
acquiring a training data set; in which the training data set includes training data and corresponding training labels; constructing a pre-training network based on a dual-driven framework of machine learning and mechanistic model; inputting the training data set into the pre-training network; performing parameter optimization with an objective of minimizing losses between network outputs and the training labels; and determining the pre-training network with optimized optimal parameters as the risk prediction model; in which, in a process of performing the parameter optimization, a feedback optimization mechanism and a dynamic weight allocation method are used, and the dynamic weight allocation method uses dynamic weighted loss.

In a training process, a core loss function uses a combination of a main loss function and an auxiliary loss function:
(1) the main loss function (for regression task)
training in predicting continuous variables (e.g., yield reduction, soil moisture content) is performed by using Weighted-Mean-Square Error (Weighted-MSE), as per the following formula (1):

$${L}_{r e g} = \frac{1}{N} {\sum }_{i = 1}^{N} {w}_{i} \cdot {( {y}_{i} - {\hat{y}}_{i} )}^{2} \qquad formula ( 1 )$$

where, L_{reg} represents the main loss, N represents a total number of samples, wᵢ represents a dynamic weight of an i-th sample, yᵢ represents a true value of the i-th sample, ŷᵢ represents a prediction value of the i-th sample; the dynamic weight wᵢ is adjusted according to a degree of climate anomaly of the sample i (for example, the dynamic weight wᵢ is increased by 3 times when a drought index is greater than 2σ, where σ represents a preset threshold, and can be can be assigned according to actual situation) and meteorological sensitivity is taken into account to impose higher penalty on prediction error of key growth periods of maize (such as a tasseling period);
(2) the auxiliary loss function (for classification task)
training in disaster level classification (mitigating class imbalance) is performed by using Focal Loss losses, as per the following formula 2:

$${L}_{c l s} = - \frac{1}{N} {\sum }_{i = 1}^{N} {α}_{t} \cdot {( 1 - {p}_{t} )}^{γ} \cdot log ( {p}_{t} ) \qquad formula ( 2 )$$

where L_{cls} represents the auxiliary loss, at represents a class balancing weight, pₜ represents a predicted probability, and γ represents a focusing parameter; in which the γ is set to 2, αₜ is weighted inversely according to a frequency of disaster level (for example, when a risk level is 5, the αₜ is set to 0.7) and adjusted a threshold thereof, and a receiver operating characteristic (ROC) curve is used to optimize a threshold shift of classification (to adapt to the distribution drift caused by climate change); and
performing multi-task learning integration to automatically learn loss weights for each task is performed by using dynamic weighted loss, as per the following formula (3):

$${L}_{total} = \frac{1}{2 {σ}_{1}^{2}} {L}_{r e g} + \frac{1}{2 {σ}_{2}^{2}} {L}_{c l s} + log {σ}_{1} {σ}_{2} \qquad formula ( 3 )$$

where Lₜₒₜₐₗ represents the core loss; in which, σ₁ and σ₂ are trainable parameters, reflecting uncertainties of the regression task and the classification task; and this step can avoid manual parameter tuning and adapt to difficulty differences of climate prediction in different regions.

Finally, following two loss functions are used for special scenario enhancement:
(1) extreme event simulation loss: enhancing robustness of the risk prediction model by adversarial generation of samples (generative adversarial network (GAN) generates rare climate models), in which an adversarial loss function for a discriminator D of the GAN is expressed by formula (4):

L_{adv}= [symbol] [log D(x)]+ [symbol] [log(1−D(G(z)))] formula (4)
where, L_{adv} represents the extreme event simulation loss, D(x) represents a judgement result of the of the discriminator D on a real data x, and G(z) represents a false data generated by a generator G according to random noise z, and the GAN is used to generate compound disaster events (such as high temperature, drought and cyclone) that have not appeared in history; and
(2) physical constraint loss: introducing agricultural mechanistic model constraint (such as water stress equation), in which the physical constraint loss is expressed by formula (5)

L_{phy}=λ·∥ŷML−yDSSAT∥₂ formula (5)
where, L_{phy} represents the physical constraint loss, λ represents an adaptive coefficient (increasing physical constraint when a model confidence is low), ŷML represents a prediction output of a Machine-Learning model, and yDSSAT represents an output result of a DSSAT physical model.

In an embodiment, steps that the climate-related data is inputted into the risk prediction model and a resultant risk result of maize cultivation is determined through computational processing of the risk prediction model include:
inputting the climate-related data into the risk prediction model, and firstly processing meteorological abnormal fluctuations by using a sliding window, then performing feature extraction and prediction, and determining the resultant risk result of maize cultivation.

In an embodiment, after the resultant risk result of maize cultivation is determined, the risk prediction method of maize cultivation further includes constructing a visual display platform. The constructing a visual display platform includes:
constructing a sliding dual platform, in which the sliding dual platform includes a first display platform and a second display platform, and a sliding between a platform page of the first display platform and a platform page of the second display platform is realized through a touch screen; the first display platform is configured to dynamically display the climate-related data through three interfaces based on different data types, and the second display platform is configured to display the resultant risk result of maize cultivation.

Based on aforementioned technical solutions, an embodiment is provided as follows.

Step 100: data are acquired by following three sub-steps.

In a first sub-step, the remote sensing data is acquired by simulating and generating the CMIP6 climate scenario data by using GCMs model, in which the CMIP6 climate scenario data includes meteorological data such as temperature, precipitation, radiation, etc. under different future emission scenarios (e.g., shared socioeconomic pathway (SSP) 1-2.6, SSP5-8.5); generating the satellite remote sensing vegetation index (normalized difference vegetation index or enhanced vegetation index) by using satellite remote sensing inversion (e.g., Landsat, MODIS) to monitor growth status of maize; and packaging the CMIP6 climate scenario data and the satellite remote sensing vegetation index into the data file; and naming the data file as the remote sensing data.

In a second sub-step, the field planting data is acquired by constructing the field internet of things sensor network (such as soil temperature and humidity sensors, weather stations, crop growth monitors) in a target maize cultivation area, collecting data of soil moisture, air temperature, precipitation and crop growth in real time, and storing the data collected in the file package named as the field planting data.

In a third sub-step, the remote sensing data and the field planting data is stored and safely transmitted by encrypting the remote sensing data and the field planting data with SHA-256 hash encryption; storing the remote sensing data and the field planting data in the cloud blockchain (such as an agricultural data link based on Hyperledger Fabric). When users request data, asymmetric encryption (Rivest-Shamir-Adleman) is used for identity verification (matching of public keys/private keys). After the identity verification passes, the remote sensing data and the field planting data is decrypted for model invocation.

Step 200: the risk prediction model is constructed by following four sub-steps.

In a first sub-step, the training data sets are prepared by collecting historical climate data, maize yield data and disaster records, and constructing the training data set with labels (input: the time-series meteorological data; labels: risk level of yield reduction).

In a second sub-step, a hybrid neural network is constructed by adopting the LSTM-Transformer hybrid neural network, in which the LSTM-Transformer hybrid neural network includes a LSTM layer and a Transformer layer, the LSTM layer is used to process long time series dependence of meteorological data (such as temperature series for 30 consecutive years), the Transformer layer is used to capture global features of key climatic factors (such as an attention weight of extreme high temperature events); and introducing the SHAP value interpretation model to quantify the contribution of each climatic factor (such as average temperature in July and precipitation in growing season) to the risk of yield reduction.

In a third sub-step, the DSSAT crop model is coupled by taking maize physiological responses (such as photosynthesis, water stress) simulated by DSSAT as physical constraints, and dynamically weighting (weights being adjusted according to season) and fusing with prediction results of the LSTM-Transformer hybrid neural network.

In a fourth sub-step, the LSTM-Transformer hybrid model and parameters thereof are dynamically trained and optimized by using the feedback optimization mechanism to adjust weights of the LSTM layer and the Transformer layer; and using a dynamic weighted loss function to assign higher weights to data in high-impact periods (such as the tasseling period).

Step 300: the resultant risk result (also referred to as risk prediction result) of maize cultivation is obtained and output by following three sub-steps.

In a first sub-step, a data pretreatment is performed by processing the climate-related data input with the sliding window (a window size of 30 days, a step size of 7 days) to smooth abnormal fluctuations (such as sudden rainstorm), so as to obtain pretreated data.

In a second sub-step, the resultant risk result of maize cultivation is predicted by the risk prediction model, by:
inputting the pretreated data into the risk prediction model; and outputting the resultant risk result of maize cultivation: the regional risk level map (for example, high-risk area: a probability of high temperature risk in Huang-Huaihai Plain in July-August under the future representative concentration pathways 8.5 scenario is larger than 60%), the optimization suggestions of planting window period (for example, it is recommended to sow 5-10 days in advance to avoid late drought in Northeast China), and the probability warning of extreme weather events (for example, in a next 10 years, a probability of continuous drought in the maize tasseling period will increase by 25%).

In a third sub-step, the visual display platform is constructed with following features:
a design of sliding dual platform, including:
   the first display platform (to dynamically display climate-related data), including: interface 1, configured to display a real-time meteorological data heat map (such as temperature and precipitation anomalies); interface 2, configured to display a change animation of the satellite remote sensing vegetation index; and interface 3, configured to display comparative analysis of historical disasters and events; and
   the second display platform (to display the resultant risk result of maize cultivation), with interactive map displaying risk level, and supporting clicking to query optimization measures (such as irrigation schemes) in specific areas.
slidingly switching display platforms by the touch screen so as to improve user experience.

Taking China Huang-Huaihai summer maize region as an example, after applying the risk prediction method, the following results can be obtained.

After 2030 SSP5-8.5 scenario data is input into the risk prediction model, the resultant risk result of maize cultivation shows:
high-risk area: Central Henan (a probability of high temperature in July is 70%), so it is recommended to plant heat-resistant maize (as a target variety type of to-be-planted maize);
planting window period adjustment: Shandong is recommended to delay sowing until mid-June (i.e., a target planting window period of to-be-planted maize)) to avoid drought in flowering period; and
platform warning: a frequency of extreme drought in the years of 2030-2035 is 15% higher than that in the year of 2020, so it is necessary to plan drought-resistant facilities in advance.

Through multi-source data fusion, hybrid model optimization and visual interaction, accurate dynamic risk prediction of maize cultivation under climate change is realized, providing support for decision of agricultural disaster prevention and reduction.

In addition, the disclosure further provides a risk prediction system of maize cultivation based on climate change trend. The risk prediction system includes a data acquisition unit, a model construction unit and a prediction unit.

The data acquisition unit is configured to acquire the climate-related data of maize cultivation. The climate-related data includes the remote sensing data and the field planting data. The remote sensing data includes the CMIP6 climate scenario data and the satellite remote sensing vegetation index.

The model construction unit is configured to construct the risk prediction model. The risk prediction model uses the LSTM-Transformer hybrid neural network to process the time-series meteorological data, introduces the SHAP value interpretation model to quantify the contribution of each climatic factor to the risk of yield reduction and couples the DSSAT crop model with the risk probability prediction module.

The prediction unit is configured to input the climate-related data into the risk prediction model, and determine the resultant risk result of maize cultivation through the computational processing of the risk prediction model. The resultant risk result of maize cultivation includes the regional risk level map, the optimization suggestions of planting window period and probability warning of extreme weather events.

The various embodiments in this specification are described in a progressive manner, with each the embodiment focusing on distinctive features that differentiate it from the other embodiments. Similar or identical parts among the embodiments can be referred to each other for understanding.

Embodiments described herein are merely for illustrating principles and implementations of the disclosure and are intended to facilitate understanding a core idea of the disclosure. Meanwhile, for those skilled in the art, there will be changes in specific implementations and an application scope based on the idea of this disclosure. Sum up, the foregoing contents of the specification should not be construed as limiting the disclosure.

What is claimed is:

1. A risk prediction method of maize cultivation based on climate change trend, comprising:
acquiring climate-related data of maize cultivation, wherein the climate-related data comprises remote sensing data and field planting data, and the remote sensing data comprises coupled model intercomparison project phase 6 (CMIP6) climate scenario data and satellite remote sensing vegetation index;
constructing a risk prediction model, wherein the risk prediction model uses a long short-term memory (LSTM)-Transformer hybrid neural network to process time-series meteorological data, introduces a SHapley Additive exPlanations (SHAP) value interpretation model to quantify a contribution of each climatic factor to a risk of yield reduction, and couples a decision support system for agrotechnology transfer (DSSAT) crop model with a risk probability predictor; and
inputting the climate-related data into the risk prediction model, and determining a resultant risk result of maize cultivation through computational processing of the risk prediction model, wherein the resultant risk result of maize cultivation comprises a regional risk level map, optimization suggestions of planting window period, and probability warning of extreme weather events.

2. The risk prediction method of maize cultivation based on climate change trend as claimed in claim 1, wherein the acquiring climate-related data of maize cultivation comprises:
simulating and generating the CMIP6 climate scenario data by using global climate models (GCMs), generating the satellite remote sensing vegetation index by using satellite remote sensing inversion, packaging the CMIP6 climate scenario data and the satellite remote sensing vegetation index into a data file, and naming the data file as the remote sensing data;
constructing a field internet of things sensor network, collecting data in a target region by using the field internet of things sensor network to obtain collected data, and storing the collected data in a file package named as the field planting data; and
storing the remote sensing data and the field planting data in a cloud blockchain after hash encryption, performing identity verification through public keys and private keys of both parties after receiving data extraction request, and carrying out data decryption and extraction after passing the identity verification.

3. The risk prediction method of maize cultivation based on climate change trend as claimed in claim 1, wherein the constructing a risk prediction model comprises:
acquiring a training data set, wherein the training data set comprises training data and corresponding training labels;
constructing a pre-training network based on a dual-driven framework of machine learning and mechanistic model; and
inputting the training data set into the pre-training network, performing parameter optimization with an objective of minimizing losses between network outputs and the training labels, and determining the pre-training network with optimized optimal parameters as the risk prediction model.

4. The risk prediction method of maize cultivation based on climate change trend as claimed in claim 3, wherein in a process of performing the parameter optimization, a feedback optimization mechanism and a dynamic weight allocation method are used, and the dynamic weight allocation method uses dynamic weighted loss.

5. The risk prediction method of maize cultivation based on climate change trend as claimed in claim 1, wherein the inputting the climate-related data into the risk prediction model, and the determining a resultant risk result of maize cultivation through computational processing of the risk prediction model, specifically comprise:
inputting the climate-related data into the risk prediction model, and firstly processing meteorological abnormal fluctuations by using a sliding window, then performing feature extraction and prediction, and determining the resultant risk result of maize cultivation.

6. The risk prediction method of maize cultivation based on climate change trend as claimed in claim 1, further comprising: constructing a visual display platform.

7. The risk prediction method of maize cultivation based on climate change trend as claimed in claim 6, wherein the constructing a visual display platform comprises:
constructing a sliding dual platform, wherein the sliding dual platform comprises a first display platform and a second display platform, and a sliding between a platform page of the first display platform and a platform page of the second display platform is realized through a touch screen; the first display platform is configured to dynamically display the climate-related data through three interfaces based on different data types, and the second display platform is configured to display the resultant risk result of maize cultivation.

8. A risk prediction system of maize cultivation based on climate change trend, comprising:
a data acquisition unit, configured to acquire climate-related data of maize cultivation, wherein the climate-related data comprises remote sensing data and field planting data, and the remote sensing data comprises CMIP6 climate scenario data and satellite remote sensing vegetation index;
a model construction unit, configured to construct a risk prediction model, wherein the risk prediction model uses a LSTM-Transformer hybrid neural network to process time-series meteorological data, introduces a SHAP value interpretation model to quantify a contribution of each climatic factor to a risk of yield reduction, and couples a DSSAT crop model with a risk probability predictor; and
a prediction unit, configured to input the climate-related data into the risk prediction model, and determine a resultant risk result of maize cultivation through computational processing of the risk prediction model, wherein the resultant risk result of maize cultivation comprises a regional risk level map, optimization suggestions of planting window period, and probability warning of extreme weather events.
